(19) United States
(12) Patent Application Publication
(10) Pub. No.: US 2016/0360792 A1
(43) Pub. Date: Dec. 15, 2016

(54) ELECTRONIC CIGARETTE, ATOMIZER ASSEMBLY AND ELECTRICAL CONNECTION STRUCTURE THEREOF

(71) Applicant: HUIZHOU KIMREE TECHNOLOGY CO., LTD. SHENZHEN BRANCH, Shenzhen (CN)

(72) Inventor: Qiuming LIU, Huizhou (CN)

(73) Assignee: HUIZHOU KIMREE TECHNOLOGY CO., LTD. SHENZHEN BRANCH, Shenzhen (CN)

(21) Appl. No.: 15/245,509

(22) Filed: Aug. 24, 2016

Related U.S. Application Data
(63) Continuation of application No. PCT/CN2014/073112, filed on Mar. 10, 2014.

(30) Foreign Application Priority Data
Feb. 26, 2014 (CN) 201420084082.8

(51) Int. Cl. A24F 47/00; H01R 13/24

(52) U.S. Cl. CPC A24F 47/008; H01R 13/2464

(57) ABSTRACT

An electrical connection structure for an atomizer assembly is provided, an electronic wire at one end of a heating wire assembly in the atomizer assembly is pressed between an outer wall of an upper electrode and an inner wall of an atomizing seat, and the outer wall of the upper electrode has a contact surface consisting of a protrusion and/or a recess, and the electronic wire is in contact with the contact surface. An atomizer assembly and an electronic cigarette each having the above electrical connection structure are also provided.

### CROSS REFERENCE TO RELATED APPLICATIONS

This application is a continuation of International Application No. PCT/CN2014/073112, filed on Mar. 10, 2014, which claims the benefit of priority to Chinese patent application No. 201420084082.8, titled “ELECTRONIC CIGARETTE, ATOMIZER ASSEMBLY AND ELECTRICAL CONNECTION STRUCTURE THEREOF”, filed with the Chinese State Intellectual Property Office on Feb. 26, 2014, both of which are hereby incorporated by reference in their entireties.

### FIELD

The present application relates to the technical field of electronic cigarettes, and particularly to an electronic cigarette, an atomizer assembly, and an electrical connection structure of the atomizer assembly.

### BACKGROUND

An electronic cigarette mainly consists of a battery assembly and an atomizer assembly. The battery assembly is used to provide power for the atomizer assembly, and the atomizer assembly generates vapor to simulate a burning effect of a cigarette.

The structure of a conventional atomizer assembly may refer to FIG. 1, and a circuit of the conventional atomizer assembly is described as follows. A positive pole (or a negative pole, and herein the positive pole is taken as an example herein) of the battery assembly is connected to an upper electrode 101. A positive electronic wire 102 is pressed by an inner wall of a silica gel atomizing seat 103 to connect with the upper electrode 101. The positive electronic wire 102 is electrically connected to one end of a heating wire assembly 104. A negative electronic wire 105 at another end of the heating wire assembly 104 is pressed by an outer wall of the silica gel atomizing seat 103 to connect with a connector 106 of a metal ember, and the connector 106 is then electrically connected to a negative pole (or a positive pole) of the battery assembly, thereby forming a loop.

As described, the positive electronic wire 102 at the end of the heating wire assembly 104 is pressed between an outer wall of the upper electrode 101 and the inner wall of the silica gel atomizing seat 103, to ensure that the positive electronic wire 102 is in constant contact with the upper electrode 101 to conduct electricity. However, as shown in FIGS. 3 and 4, the cylindrical outer surface of the upper electrode 101 is too smooth, thus the positive electronic wire 102 is in point contact or line contact with the upper electrode 101. Especially, in a case that the atomizer assembly sways when being screwed to a battery assembly, the positive electronic wire 102 is apt to make poor contact or no contact with the upper electrode 101, resulting in an unstable resistance value of the heating wire, a great difference between amounts of vapor atomized by the product at different times, and an unstable quality of the product.

In another method, the electronic wire is required to be soldered to the electrode, which can improve the contact stability. However, poor soldering such as insufficient soldering, false soldering may be caused in the soldering, and also an electrode hole may be blocked in the soldering. In another aspect, residuals in the soldering may cause safety risks to a user.

Therefore, in view of the above situations, an important technical issue to be addressed by the person skilled in the art presently is to ensure a reliable contact between the upper electrode and the electronic wire without causing other disadvantages.

### SUMMARY

In view of this, an electrical connection structure of an atomizer assembly is provided according to the present application, to allow an electronic wire to be in multipoint contact with an upper electrode, and effectively avoid a poor contact between the electronic wire and the upper electrode during assembly and use; and also to allow the upper electrode to be in good contact with the electronic wire in a case that the atomizer assembly sways when being screwed to a battery assembly. In addition, since this structure does not require soldering, corresponding issues caused by soldering are also avoided.

An atomizer assembly employing the above electrical connection structure of the atomizer assembly is further provided according to the present application.

An electronic cigarette employing the above electrical connection structure of the atomizer assembly is further provided according to the present application.

The following technical solutions are provided according to the present application.

An electrical connection structure of the atomizer assembly is provided, an electronic wire at one end of a heating wire assembly in the atomizer assembly is pressed between an outer wall of an upper electrode and an inner wall of an atomizing seat, and the outer wall of the upper electrode has a contact surface consisting of a protrusion and/or a recess, and the electronic wire is in contact with the contact surface.

Preferably, the contact surface consists of a plurality of protrusions and/or a plurality of recesses.

Preferably, the contact surface is arranged on an end of the upper electrode.

Preferably, the contact surface has a wave-like texture consisting of a plurality of recesses arranged at intervals.

Preferably, the recesses are annular recesses perpendicular to an axial direction of the upper electrode.

Preferably, the plurality of annular recesses are arranged at equal intervals.

Preferably, the contact surface has an embossed texture consisting of a plurality of staggered recesses.

Preferably, an inner wall of a connector has a contact surface with a wave-like texture consisting of a plurality of recesses arranged at intervals, and the electronic wire is in contact with the contact surface with the wave-like texture.

An atomizer assembly is provided, which is applicable to an electronic cigarette, the atomizer assembly includes the above electrical connection structure for the atomizer assembly.

An electronic cigarette is provided, which includes a battery assembly and an atomizer assembly, and the atomizer assembly is the above atomizer assembly.

According to the above technical solutions, in the electronic cigarette, the atomizer assembly, and the electrical connection structure of the atomizer assembly according to the present application, the outer wall of the upper electrode has a contact surface consisting of a protrusion and/or a recess, and the electronic wire is tightly pressed by the atomizing seat to be in multipoint contact with the contact surface of the upper electrode, thereby effectively avoiding the poor contact between the electronic wire and the upper electrode during assembly and use. Also, in a case that the atomizer assembly sways when being screwed to a battery assembly, the upper electrode is still in good contact with the electronic wire. Additionally, this structure does not require soldering, thereby avoiding issues caused by soldering such as manufacturing defects caused by soldering and safety risks to a user caused by soldering residuals.

### BRIEF DESCRIPTION OF THE DRAWINGS

For more clearly illustrating embodiments of the present application or technical solutions in the conventional technology, drawings referred to describe the embodiments or the conventional technology will be briefly described hereinafter. Apparently, the drawings in the following description are only some examples of the present application, and for the person skilled in the art, other drawings may be obtained based on these drawings without any creative efforts.

FIG. 1 is a schematic view showing the appearance of an atomizer assembly in the conventional technology;

FIG. 2 is a sectional view showing the structure of the atomizer assembly in the conventional technology;

FIG. 3 is a schematic view showing the appearance of an upper electrode in the conventional technology;

FIG. 4 is a sectional view showing the structure of the upper electrode in the conventional technology;

FIG. 5 is a schematic view showing the structure of an upper electrode according to a first embodiment of the present application;

FIG. 6 is a sectional view of FIG. 5;

FIG. 7 is a perspective view of the upper electrode according to the first embodiment of the present application;

FIG. 8 is a partial view showing the assembly of the upper electrode according to the first embodiment of the present application;

FIG. 9 is a schematic view showing the structure of the upper electrode in FIG. 8 cooperating with an electronic wire;

FIG. 10 is a schematic view showing the structure of an atomizer assembly according to the first embodiment of the present application;

FIG. 11 is a schematic view showing the structure of the upper electrode in FIG. 10 cooperating with the electronic wire;

FIG. 12 is an exploded view of the atomizer assembly according to the first embodiment of the present application;

FIG. 13 is a schematic view showing the structure of an upper electrode according to a second embodiment of the present application;

FIG. 14 is a sectional view of FIG. 13;

FIG. 15 is a schematic view showing the structure of a connector in the conventional technology;

FIG. 16 is a sectional view of FIG. 15;

FIG. 17 is a schematic view showing the structure of a connector according to the second embodiment of the present application;

FIG. 18 is a sectional view of FIG. 17; and

FIG. 19 is a schematic view showing the structure of an atomizer assembly according to the second embodiment of the present application.

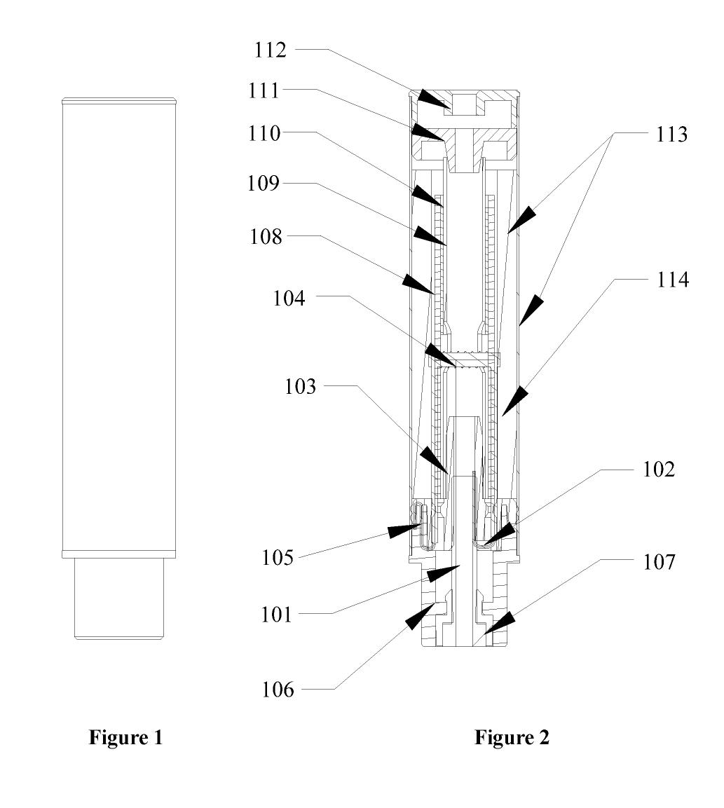

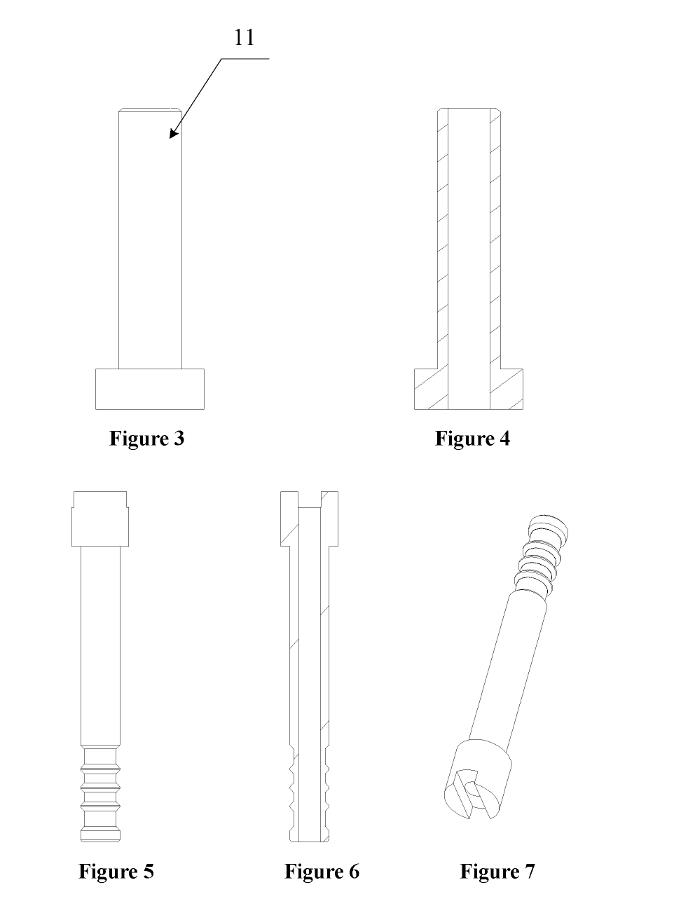

Reference numerals in the conventional technology as shown in FIGS. 2, 15, 16:

| | | | |
|---|---|---|---|
| 101 | upper electrode, | 102 | positive electronic wire, |
| 103 | atomizing seat, | 104 | heating wire assembly, |
| 105 | negative electronic wire, | 106 | connector, |
| 107 | insulation ring, | 108 | cloth, |
| 109 | second PVC fiberglass | 110 | first PVC fiberglass |
| | sleeving, | | sleeving, |
| 111 | sealing ring, | 112 | suction nozzle cover, |
| 113 | atomizing sleeve, and | 114 | cotton. |

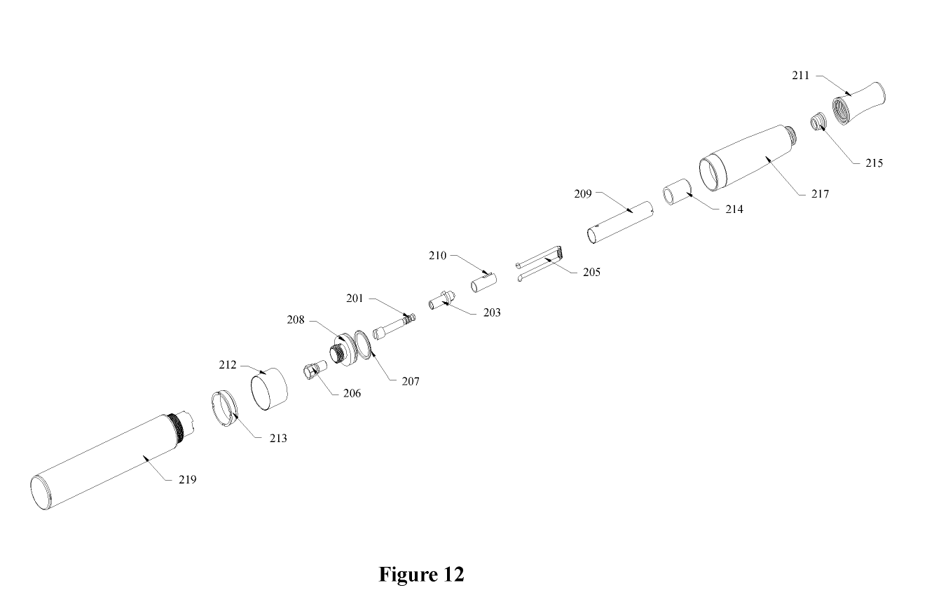

Reference numerals in the first embodiment of the solution as shown in FIGS. 5 to 12:

| | | | |
|---|---|---|---|
| 201 | upper electrode, | 202 | electronic wire, |
| 203 | atomizing seat, | 204 | fiberglass wick, |
| 205 | heating wire, | 206 | upper insulation ring, |
| 207 | sealing | 208 | externally threaded connecting |
| | ring, | | member, |
| 209 | inner steel tube, | 210 | PVC fiberglass sleeving, |
| 211 | suction nozzle, | 212 | decoration member, |
| 213 | connection member, | 214 | silica gel sleeve. |
| 215 | sealing cover, | 217 | liquid reservoir, |

| | |
|---|---|
| 216 | liquid chamber within the inner steel tube at an end |
| | corresponding to heating wire, |
| 218 | liquid chamber within the inner steel tube in communication |
| | with liquid reservoir, |
| 219 | battery assembly. |

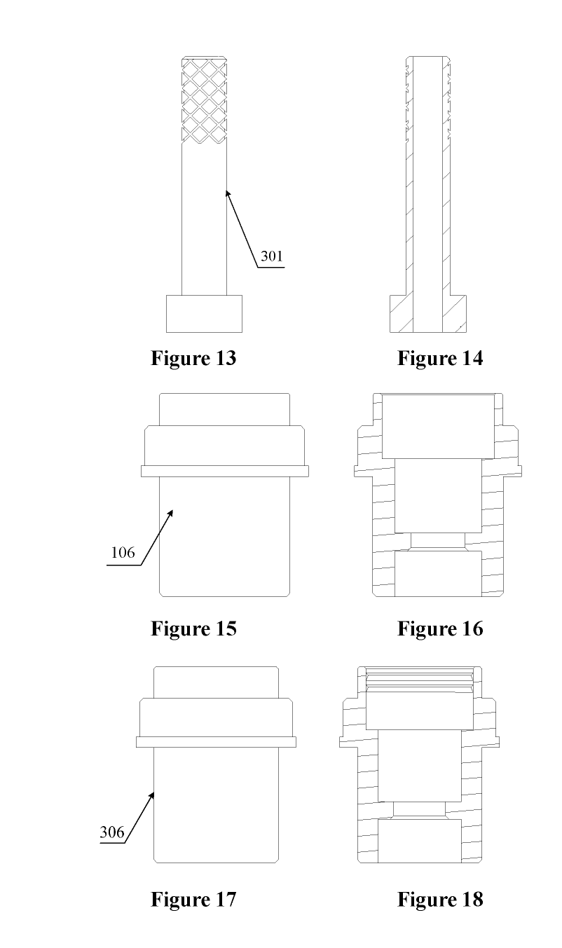

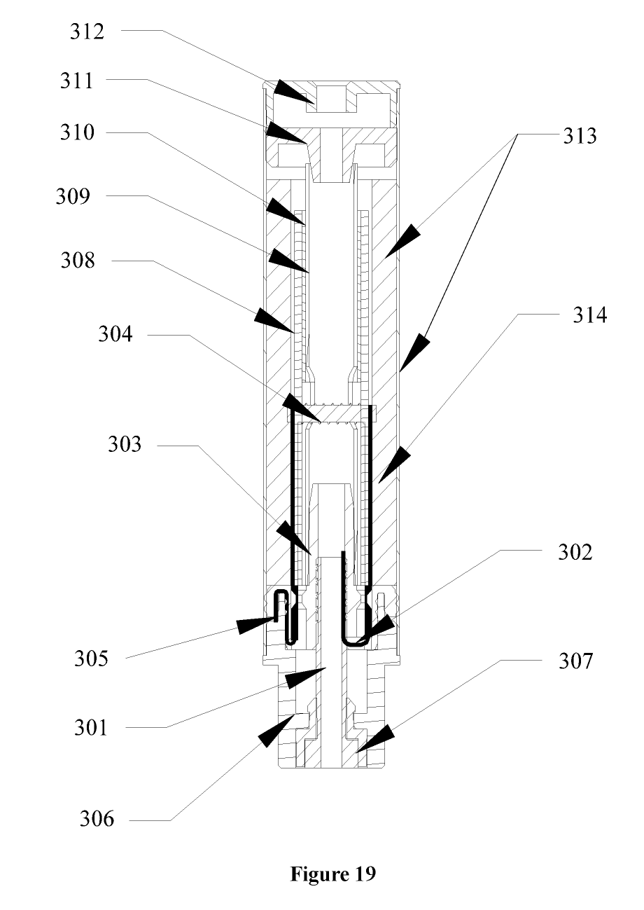

Reference numerals in the second embodiment of the solution as shown in FIGS. 13, 14 and 17 to 19:

| | | | |
|---|---|---|---|
| 301 | upper electrode, | 302 | positive electronic wire, |
| 303 | atomizing seat, | 304 | heating wire assembly, |
| 305 | negative electronic wire, | 306 | connector, |
| 307 | insulation ring, | 308 | cloth, |
| 309 | second PVC fiberglass | 310 | first PVC fiberglass |
| | sleeving, | | sleeving, |
| 311 | sealing ring, | 312 | suction nozzle cover, |
| 313 | atomizing sleeve, and | 314 | cotton. |

### DETAILED DESCRIPTION

An electrical connection structure of the atomizer assembly is provided according to the present application, to allow an electronic wire to be in multipoint contact with an upper electrode, and effectively avoid a poor contact between the electronic wire and the upper electrode during assembly and use; and also to allow the upper electrode to be in good contact with the electronic wire in a case that the atomizer assembly sways when being screwed to a battery assembly. In addition, since this structure does not require soldering, corresponding issues caused by soldering are also avoided.

The technical solutions of embodiments of the present application will be clearly and completely described hereinafter in conjunction with the drawings of the embodiments of the present application. Apparently, the embodiments described are only some examples of the present application, and not all implementations. Other embodiments obtained by the person skilled in the art based on the embodiments of the present application without any creative efforts all fall into the scope of the present application.

In the electrical connection structure of the atomizer assembly according to an embodiment of the present application, an electronic wire at one end of a heating wire assembly in the atomizer assembly is pressed between an outer wall of an upper electrode and an inner wall of an atomizing seat, and the outer wall of the upper electrode has a contact surface consisting of a protrusion and/or a recess, thus the electronic wire is allowed to be in contact with the contact surface. It may be understood that, the above protrusion and recess are defined by taking the outer wall of the upper electrode as a reference.

According to the above technical solutions, in the electrical connection structure of the atomizer assembly according to the embodiment of the present application, the outer wall of the upper electrode has a contact surface consisting of a protrusion and/or a recess, and the electronic wire is tightly pressed by the atomizing seat to be in multipoint contact with the contact surface of the upper electrode, thereby effectively avoiding the poor contact between the electronic wire and the upper electrode during assembly and use. Also, in a case that the atomizer assembly sways when being screwed to a battery assembly, the upper electrode is still in good contact with the electronic wire. Additionally, this structure does not require soldering, thereby avoiding issues caused by soldering such as manufacturing defects caused by soldering and safety risks to a user caused by soldering residuals.

As a preferable solution, the contact surface consists of multiple protrusions and/or multiple recesses, thereby constituting a relatively complicated contact surface, to allow the contact surface to contact the electronic wire at more points.

Since the conventional upper electrode generally contacts, at its end, with an electronic wire by cooperating with an atomizing seat, in an embodiment according to this solution, the contact surface is arranged at an end of the upper electrode, and the structure may refer to FIGS. 5-7, 13 and 14. Of course, according to an actual structure of the atomizer assembly, the position for arranging the contact surface can be adjusted appropriately by the person skilled in the art, which will not be described here.

In a first embodiment according to this solution, the contact surface of the upper electrode 201 has a wave-like texture and is consisted of multiple recesses arranged at intervals, and the structure of the contact surface may refer to FIGS. 5 to 12. The electronic wire 202 may be tightly pressed by an atomizing seat 203 made of a silica gel material to be in multipoint contact with the wave-like texture of the upper electrode 201. Of course, the atomizing seat 203 may also be made of materials other than silica gel, which is not limited here.

Considering that the outer circumferential surface of the upper electrode 201 is cylindrical, the recesses may be annular recesses perpendicular to an axial direction of the upper electrode 201. Preferably, the multiple annular recesses are arranged at equal intervals.

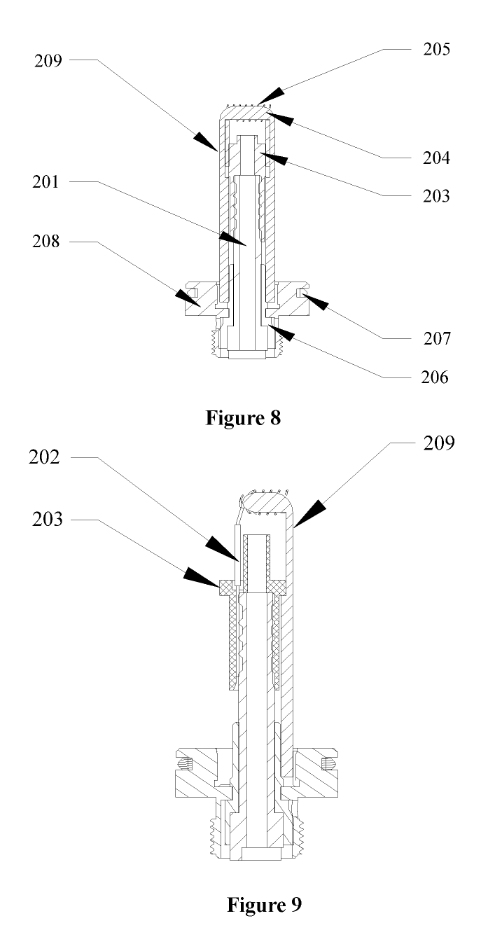

The structure of this solution is further described in detail hereinafter with reference to the assembly drawing in FIGS. 8 to 11.

A heating wire assembly (including a fiberglass wick 204) is rested on a PVC fiberglass sleeving 210, and one electronic wire 202 of the heating wire assembly passes through the atomizing seat 203 and enters an inner hole of the atomizing seat 203, and is then disposed between the atomizing seat 203 and the upper electrode 201. The electronic wire 202 is tightly pressed by the atomizing seat 203, to allow the electronic wire 202 to be in multipoint contact with the wave-like texture on the upper electrode 203.

Another electronic wire of the heating wire assembly extends upward and is bent, and then is connected to an inner steel tube 209 by spot soldering, and the inner steel tube 209 is in contact with an externally threaded connecting member 208. In this way, the electronic wires at two ends of the heating wire 205 are electrically connected to the upper electrode 201 of an upper insulation ring and the externally threaded connecting member 208 respectively.

Circuit: the atomizing seat 203 sleeved on the upper electrode 201 presses the electronic wire 202 to allow the upper electrode 201 to be in contact with the electronic wire 202, and the electronic wire 202 is electrically connected to the heating wire 205, and then the electronic wire at another end of the heating wire 205 is bent and then is in press contact with the inner steel tube 209 and is electrically connected to the externally threaded connecting member 208, thereby forming the circuit.

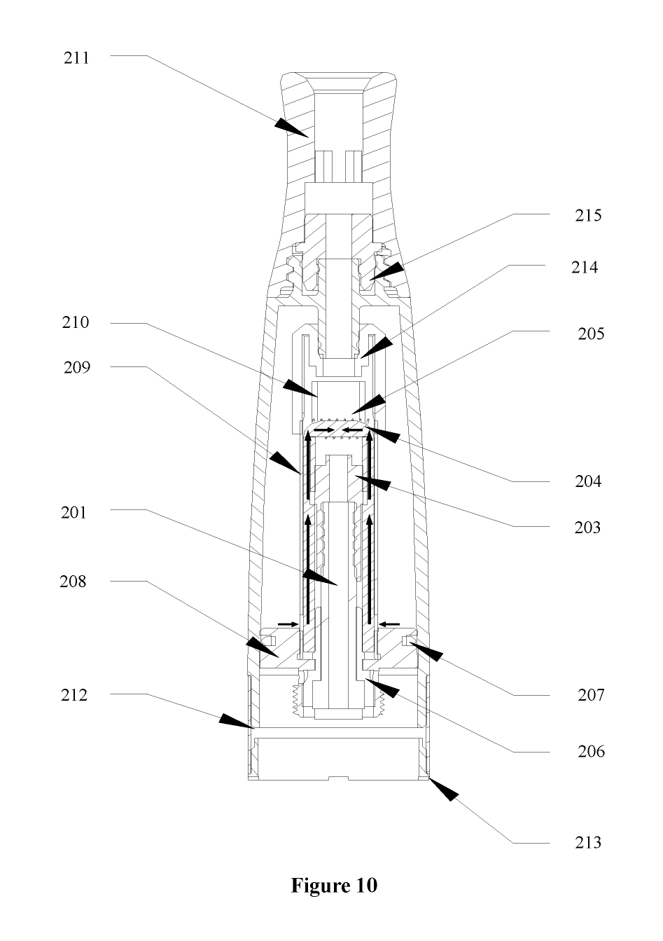

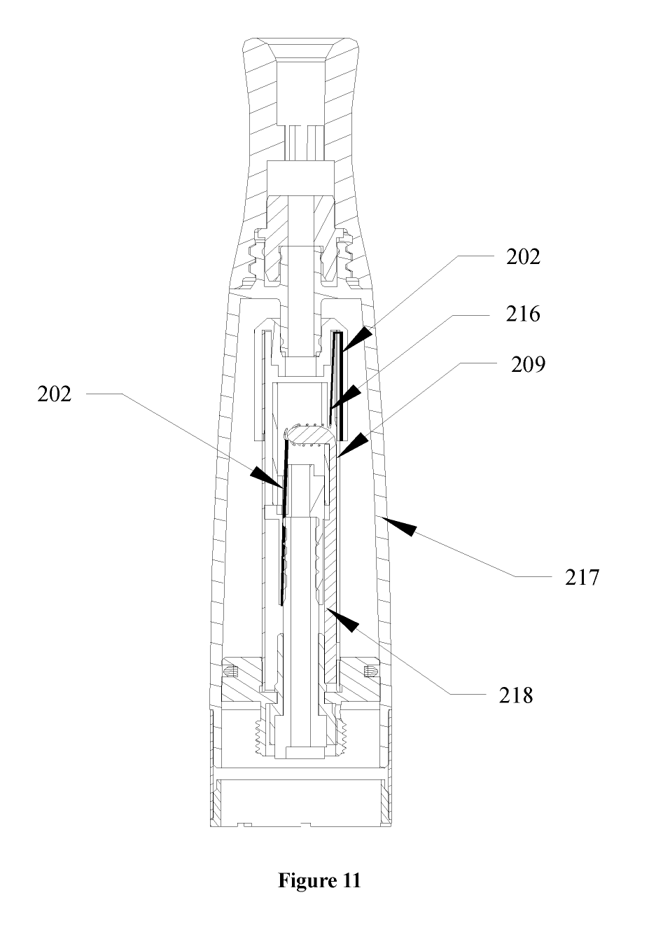

Liquid path: cigarette liquid enters into the steel tube via a hole in the inner steel tube 209, and then crawls over the fiberglass wick 204 and finally reaches the heating wire 205, and the cigarette liquid is heated by the heating wire 205 to be atomized to generate vapor. The path indicated by multiple arrows in FIG. 10 refers to the liquid path.

In a second embodiment according to this solution, the contact surface of the upper electrode 301 has an embossed texture consisting of multiple staggered recesses, for example, a contact surface with mesh texture or sandblasted texture, and the structure of the contact surface may refer to FIGS. 13, 14 and 17-19. The general solution of this embodiment is substantially same as the first embodiment, and may refer to the description of the above structure, and in this embodiment, only the type of the contact surface is changed. The upper electrode 301 is in press contact with the positive electronic wire 302 (may also be a negative electronic wire), and an electrical conductive portion therebetween is not smooth, thus the upper electrode 301 and the positive electronic wire 302 are in multipoint contact with each other. This solution may have the following beneficial effects. The contact area is large, which facilitates conducting electricity, and thus the issue of poor contact can be addressed. The friction between the upper electrode 301 and the atomizing seat 303 is increased, thus, the issue of loosening of the upper electrode can be addressed.

For further optimizing the above technical solutions, an inner wall of the connector 306 has a contact surface with a wave-like texture consisting of multiple recesses arranged at intervals, and the electronic wire is allowed to be in contact with the contact surface having the wave-like texture. An annular concave-convex texture is provided on the electrical conductive portion of the electrode of the connector 306 where the electrode of the connector 306 is in press contact with the electronic wire, and in this way, the following beneficial effects can be obtained. The contact area is large, which facilitates conducting electricity, and thus the issue of poor contact can be addressed. The friction between the electrode of the connector 306 and the atomizing seat 303 is increased, thus, the issue of loosening of the atomizing seat 303 can be addressed. The above structure may also be employed in the corresponding threaded member.

As examples, all the contact surfaces are described as consisting of recessed structures, and of course, the outer circumferential surface of the upper electrode may also be provided with a contact surface with protruding structures, to allow the contact surface to be in multipoint contact with the electronic wire. The principle of the contact surface with protruding structures may refer to the above recessed structures, and the specific structure can be chose by the person skilled in the art according to practical requirements, which will not be described herein.

An atomizer assembly is further provided according to the present application, which is applicable to an electronic cigarette, and the atomizer assembly is improved by including the above described connection structure.

An electronic cigarette is further provided according to the present application, which includes a battery assembly and an atomizer assembly. The improvement in the electronic cigarette lies in that the atomizer assembly is the above atomizer assembly.

In conclusion, in the electrical connection structure of the atomizer assembly according to an embodiment of the present application, the outer wall of the upper electrode has a contact surface consisting of a protrusion and/or a recess, and the electronic wire is tightly pressed by the atomizing seat to be in multipoint contact with the contact surface of the upper electrode, thereby effectively avoiding the poor contact between the electronic wire and the upper electrode during assembly and use. Also, in a case that the atomizer assembly sways when being screwed to a battery assembly, the upper electrode is still in good contact with the electronic wire. Additionally, this structure does not require soldering, thereby avoiding issues caused by soldering such as manufacturing defects caused by soldering and safety risks to a user caused by soldering residuals. An atomizer assembly and an electronic cigarette each having the above electrical connection structure are further provided according to embodiments of the present application.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

What is claimed is:

1. An electrical connection structure for an atomizer assembly, an electronic wire at one end of a heating wire assembly in the atomizer assembly being pressed between an outer wall of an upper electrode and an inner wall of an atomizing seat, wherein, the outer wall of the upper electrode has a contact surface consisting of a protrusion and/or a recess, and the electronic wire is in contact with the contact surface.

2. The electrical connection structure for the atomizer assembly according to claim 1, wherein the contact surface consists of a plurality of protrusions and/or a plurality of recesses.

3. The electrical connection structure for the atomizer assembly according to claim 2, wherein the contact surface is arranged on an end of the upper electrode.

4. The electrical connection structure for the atomizer assembly according to claim 1, wherein the contact surface has a wave-like texture consisting of a plurality of recesses arranged at intervals.

5. The electrical connection structure for the atomizer assembly according to claim 4, wherein the recesses are annular recesses perpendicular to an axial direction of the upper electrode.

6. The electrical connection structure for the atomizer assembly according to claim 5, wherein the plurality of annular recesses are arranged at equal intervals.

7. The electrical connection structure for the atomizer assembly according to claim 2, wherein the contact surface has a wave-like texture consisting of a plurality of recesses arranged at intervals.

8. The electrical connection structure for the atomizer assembly according to claim 7, wherein the recesses are annular recesses perpendicular to an axial direction of the upper electrode.

9. The electrical connection structure for the atomizer assembly according to claim 8, wherein the plurality of annular recesses are arranged at equal intervals.

10. The electrical connection structure for the atomizer assembly according to claim 3, wherein the contact surface has a wave-like texture consisting of a plurality of recesses arranged at intervals.

11. The electrical connection structure for the atomizer assembly according to claim 10, wherein the recesses are annular recesses perpendicular to an axial direction of the upper electrode.

12. The electrical connection structure for the atomizer assembly according to claim 11, wherein the plurality of annular recesses are arranged at equal intervals.

13. The electrical connection structure for the atomizer assembly according to claim 1, wherein the contact surface has an embossed texture consisting of a plurality of staggered recesses.

14. The electrical connection structure for the atomizer assembly according to claim 2, wherein the contact surface has an embossed texture consisting of a plurality of staggered recesses.

15. The electrical connection structure for the atomizer assembly according to claim 3, wherein the contact surface has an embossed texture consisting of a plurality of staggered recesses.

16. The electrical connection structure for the atomizer assembly according to claim 1, wherein an inner wall of a connector has a contact surface with a wave-like texture consisting of a plurality of recesses arranged at intervals, and the electronic wire is in contact with the contact surface with the wave-like texture.

17. An atomizer assembly, applicable to an electronic cigarette, wherein the atomizer assembly comprises the electrical connection structure for the atomizer assembly according to claim 1.

18. An electronic cigarette, comprising a battery assembly and an atomizer assembly, wherein the atomizer assembly is the atomizer assembly according to claim 17.
